(19) United States
(12) Patent Application Publication
(10) Pub. No.: US 2013/0100698 A1
(43) Pub. Date: Apr. 25, 2013

(54) SPREAD ILLUMINATING APPARATUS

(71) Applicant: MINEBEA CO., LTD., Kitasaku-gun (JP)

(72) Inventors: Tomoko OHARA, Kitasaku-gun (JP); Taku YAMADA, Kitasaku-gun (JP)

(73) Assignee: MINEBEA CO., LTD., Kitasaku-gun (JP)

(21) Appl. No.: 13/654,709

(22) Filed: Oct. 18, 2012

(30) Foreign Application Priority Data
Oct. 21, 2011 (JP) 2011-231794

(51) Int. Cl. F21V 13/02; F21V 13/12

(52) U.S. Cl. 362/608

(57) ABSTRACT

A spread illuminating apparatus includes a light guide plate in which two side end surfaces that oppose each other are incident light surfaces and one of two principal surfaces that oppose each other is an emitting surface; and a pair of light sources that are respectively arranged along the two incident light surfaces of the light guide plate and that are alternately illuminated, wherein light absorbers are formed in regions toward the incident light surfaces of one or both of the principal surfaces of the light guide plate.

### BACKGROUND OF THE INVENTION

1. Field of the Invention

The present invention relates to a backlight for a liquid crystal display device, and in particular to a spread illuminating apparatus that is suitable as a backlight for a liquid crystal display device used in a naked eye 3D display system.

2. Description of the Related Art

In recent years, a naked eye 3D display system in which a viewer of the display system can visually recognize a stereoscopic (3D) image without using a specialized tool such as glasses has been attracting attention. Conventionally, in such a naked eye 3D display system, a technology has been proposed in which a left-eye image and a right-eye image displayed on a liquid crystal display device are respectively supplied to only the left eye and only the right eye by light distribution control of illumination light from a backlight, and thereby a naked eye 3D display is realized (for example, refer to Japanese Patent Application National Publication No. 2010-541020).

As shown in FIG. 2, such a display device 110 includes a liquid crystal display panel 120, a backlight 130 that supplies light to the liquid crystal display panel 120, and a two-sided prism film 140 that is disposed between the liquid crystal display panel 120 and the backlight 130. The backlight 130 includes a light guide plate 125, a right-eye image solid-state light source 132 disposed on a first light input surface 131 of the light guide plate 125, and a left-eye image solid-state light source 134 disposed on a second light input surface 133. On an underside surface 136 of the light guide plate 125, a linear prism is formed across the entire surface as an optical path conversion unit.

In the two-sided prism film 140, a surface on a light output surface 135 side of the light guide plate 125 includes a three-sided prism line extending approximately in parallel to the first and second light input surfaces 131 and 133, and a surface on the display panel 120 side includes a cylindrical prism line extending approximately in parallel to the first and second light input surfaces 131 and 133. With this structure, the two-sided prism film 140 functions to convert a direction of light that has entered into the light guide plate 125 from the first light input surface 131 and exited from the light output surface 135 into a direction of the right eye of a viewer, and to convert a direction of light that has entered into the light guide plate 125 from the second light input surface 133 and exited from the light output surface 135 into a direction of the left eye of a viewer.

The display device 110 alternately displays a right-eye image and a left-eye image on the display panel 120, and selectively supplies the right-eye image to the right eye of the viewer and the left-eye image to the left eye of the viewer by illuminating the right-eye image solid-state light source 132 when displaying the right-eye image (and simultaneously turning off the left-eye image solid-state light source 134) and illuminating the left-eye image solid-state light source 134 when displaying the left-eye image (and simultaneously turning off the right-eye image solid-state light source 132). The display device 110 includes a synchronous driving element 150 and an image source 160 in order to enable the above-described operation.

In the backlight 130 shown in FIG. 2, in many cases, in order to improve the uniformity of the brightness of illumination light, regions near the first and second light input surfaces 131 and 133 in which the brightness can easily become non-uniform due to the existence of areas of remarkably high brightness (bright lines) and the like, of the light output surface 135 are blocked as non-effective emitting regions, and the center of the light output surface 135 in which the brightness is relatively uniform is configured as an effective emitting region, such that only light emitted from the effective emitting region is used as illumination light.

In a naked eye 3D display system, in general, a so-called crosstalk problem has been known, in which the right-eye image and the left-eye image are not completely separated and the right-eye image is supplied to the left eye of the viewer at a certain level of brightness and the left-eye image is supplied to the right eye of the viewer at a certain level of brightness.

For example, in the display device 110, there are cases in which a portion of light that has entered into the light guide plate 125 from the right-eye image solid-state light source 132 via the first light input surface 131 reaches the second light input surface 133 without being emitted from the light output surface 135, and this portion of light is reflected off the second light input surface 133 and then emitted from the light output surface 135. Thereby, the emitting direction of this emitted light is converted into a direction of the left eye of the viewer. This kind of phenomenon (and the symmetrical phenomenon regarding light that has entered into the light guide plate 125 from the left-eye image solid-state light source 134 via the second light input surface 133) is one factor that leads to crosstalk.

If crosstalk occurs, the stereoscopic effect of the image is lost. Therefore, it is preferable to be able to reduce crosstalk in order to improve the display quality of the stereoscopic image.

### SUMMARY OF THE INVENTION

Considering the above problems, an object of the present invention is to provide a spread illuminating apparatus that is capable of reducing crosstalk in a spread illuminating apparatus that is suitable as a backlight of a naked eye 3D display system.

The embodiments of the invention described below are examples of the structure of the present invention. In order to facilitate the understanding of the various structures of the present invention, the explanations below are divided into aspects. Each aspect does not limit the technical scope of the present invention, and the technical scope of the present invention can also include structures in which a portion of the components in the aspects below are substituted or deleted, or another component is added upon referring to the best modes for carrying out the invention.

According to a first aspect of the present invention, there is provided a spread illuminating apparatus including: a light guide plate in which two side end surfaces that oppose each other are incident light surfaces and one of two principal surfaces that oppose each other is an emitting surface, and a pair of light sources that are respectively arranged along the two incident light surfaces of the light guide plate and are alternately illuminated, wherein light absorbers are formed in regions toward (meaning near) the incident light surfaces of one or both of the principal surfaces of the light guide plate.

With this structure, by forming light absorbers in regions toward the incident light surfaces of one or both of the principal surfaces of the light guide plate, light that has entered the light guide plate from one incident light surface and then is guided toward the other incident light surface without being emitted from the light emitting surface is at least partially absorbed by the light absorber formed in a region toward the other incident light surface before reaching the other incident light surface. Thus, light emitted from the emitting surface after being reflected by the other incident light surface, which is a factor leading to crosstalk, can be reduced and thereby crosstalk can be reduced.

In the spread illuminating apparatus according to the first aspect, the light absorbers are formed in a strip shape that extends parallel to a lengthwise direction of the incident light surfaces of the light guide plate.

With this structure, by forming the light absorbers in a strip shape that extends parallel to the lengthwise direction of the incident light surfaces of the light guide plate, light which is a factor leading to crosstalk can be effectively absorbed.

In the spread illuminating apparatus according to the first aspect, the light absorbers are formed in regions that are more toward the incident light surfaces than an effective emitting region disposed at the center in a light guide direction of the emitting surface of the light guide plate.

In the spread illuminating apparatus of this aspect, by forming the light absorbers in regions that are more toward the incident light surfaces than the effective emitting region disposed at the center in the light guide direction of the principal surfaces of the light guide plate, light which is a factor leading to crosstalk can be effectively absorbed.

In addition, in the spread illuminating apparatus of this aspect, since the light absorbers are formed in regions that are more toward the incident light surfaces than the effective emitting region, light which has entered the light guide plate from one of the incident light surfaces and immediately reaches the light absorber formed in a region toward the one incident light surface of one or both of the principal surfaces of the light guide plate would mainly be emitted from the non-effective emitting regions which are regions that are more toward the incident light surfaces than the effective emitting region of the principal surfaces of the light guide plate in the case that such light absorbers did not exist, and such light is one factor leading to such regions becoming regions of remarkably high brightness (bright lines).

Therefore, in the spread illuminating apparatus of this aspect, since this kind of light which is a factor leading to the occurrence of bright lines is absorbed, the uniformity of the brightness of light emitted from the light guide plate can be improved. Thus, the overall length of the light guide plate that is necessary for securing an effective emitting region of a prescribed length on the emitting surface of the light guide plate can be reduced, and this contributes to size reduction of the spread illuminating apparatus.

Further, in a conventional spread illuminating apparatus, since a light blocking unit or the like is normally provided on the non-effective emitting regions on the emitting surface of the light guide plate, light emitted from the non-effective emitting regions is not utilized as illumination light in the first place. Therefore, in the spread illuminating apparatus of this aspect, even if there is light which has entered the light guide plate from one of the incident light surfaces and is immediately absorbed by the light absorber formed in a region toward the one incident light surface of one or both of the principal surfaces of the light guide plate, the absorption of such light has almost no effect on the brightness of illumination light that is emitted from the effective emitting region.

In this way, the light absorbers in the spread illuminating apparatus of this aspect function mainly to selectively absorb light which is a factor leading to crosstalk and light which cannot be utilized as illumination light in the first place from light that is guided within the light guide plate after light emitted from the light sources enters into the light guide plate. Thereby, compared to a conventional spread illuminating apparatus, crosstalk can be reduced with hardly any reduction in the brightness of illumination light, and the uniformity of the brightness can be improved.

In the spread illuminating apparatus according to the first aspect, a two-sided prism sheet is disposed on the emitting surface side of the light guide plate.

With the structures described above, the spread illuminating apparatus of the present invention can reduce crosstalk in a spread illuminating apparatus that is suitable as a backlight of a naked eye 3D display system.

### BRIEF DESCRIPTION OF THE DRAWINGS

FIG. 1A is a side view illustrating the essential parts of a spread illuminating apparatus according to one embodiment of the present invention, and FIG. 1B is a side view illustrating a light guide plate of the spread illuminating apparatus shown in FIG. 1A; and

FIG. 2 is a side view illustrating one example of a conventional naked eye 3D display system.

### DETAILED DESCRIPTION OF THE PREFERRED EMBODIMENTS

Embodiments of the present invention will be explained below based on the attached drawings. The drawings, which show all or part of a spread illuminating apparatus, are schematic views which highlight the characteristics of the present invention for explanation, and the relative dimensions of each illustrated part do not necessarily reflect the actual reduced scale.

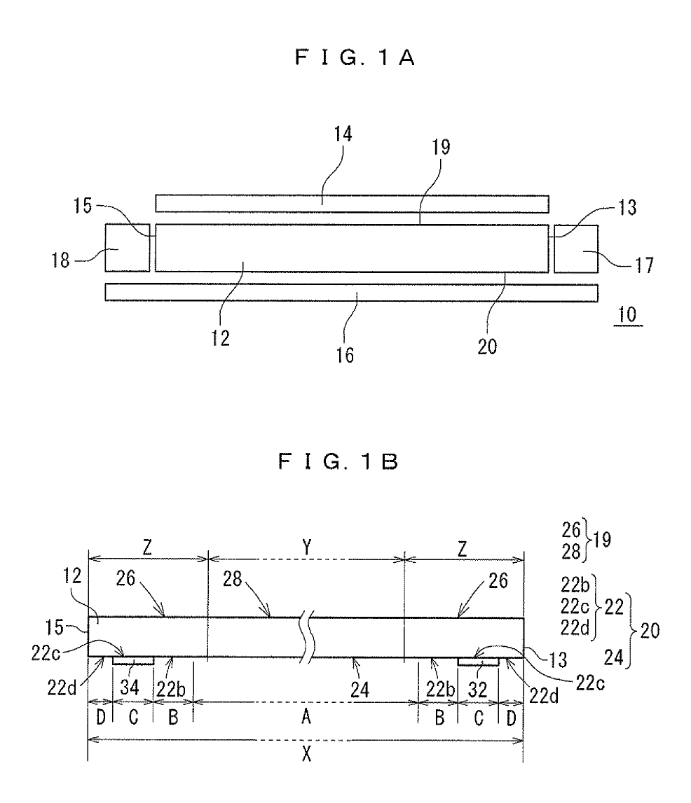

FIG. 1A is a side view illustrating the essential parts of a spread illuminating apparatus according to one embodiment of the present invention. A spread illuminating apparatus 10 shown in FIG. 1A is a sidelight-type spread illuminating apparatus including a light guide plate 12 and light sources 17 and 18. The light guide plate 12 is a plate-shaped light guide in which one of the two principal surfaces that oppose each other is an emitting surface 19, The two side end surfaces that oppose each other are used as incident light surfaces 13 and 15, and the light sources 17 and 18 are respectively arranged along the incident light surfaces 13 and 15.

In the present embodiment, the light sources 17 and 18 include a plurality of light-emitting diodes arranged along the lengthwise direction of the incident light surfaces 13 and 15. Also, in the spread illuminating apparatus 10, a two-sided prism sheet 14 is disposed on the emitting surface 19 side of the light guide plate 12, and a reflective sheet (having a reflectance of, for example, 98% or greater) is disposed as an optical sheet 16 on a principal surface (underside surface) 20 on the opposite side of the emitting surface 19 of the light guide plate 12.

The light guide plate 12 is made by molding a transparent resin material such as a methacrylic resin or a polycarbonate resin. Light which has entered into the light guide plate 12 through the incident light surfaces 13 and 15 is propagated toward the respective opposing incident light surface 15 or 13 side while repeating total reflection between the emitting surface 19 and the underside surface 20. In this process, the propagated light is uniformly emitted from the emitting surface 19. In this respect, in the spread illuminating apparatus 10, a direction (direction from left to right on the paper surface in FIG. 1) that is orthogonal to the incident light surfaces 13 and 15 of the light guide plate 12 is referred to as the light guide direction.

In the following explanation, with respect to the components of the light guide plate 12, the length in the light guide direction may be simply referred to as the “length”, the length in a direction (vertical direction relative to the paper surface in FIG. 1) that is orthogonal to the light guide direction within a plane that is parallel to the principal surfaces (the emitting surface 19 and the underside surface 20) will be referred to as “width”, and the length in a direction (up-down direction on the paper surface in FIG. 1) that is orthogonal to the principal surfaces of the light guide plate 12 will be referred to as the “thickness”.

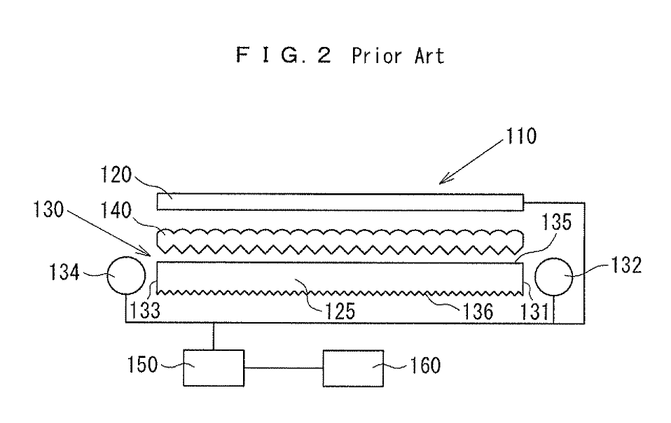

The spread illuminating apparatus 10 is suitably used as a backlight of a liquid crystal panel in a naked-eye 3D display system as described above referring to FIG. 2. The two-sided prism sheet 14 includes, for example, the same structure as that of a two-sided prism film 140 shown in FIG. 2. However, the present invention is not limited by the structure of the two-sided prism sheet 14, and the two-sided prism sheet 14 can have any appropriate structure as long as it can fulfill the same functions as the two-sided prism film 140.

As shown in FIG. 1B, the emitting surface 19 of the spread illuminating apparatus 10 includes an effective emitting region 28 having a prescribed length Y at the center in the light guide direction and non-effective emitting regions 26 at the outsides of the effective emitting region 28 (the incident light surface 13 side and the incident light surface 15 side). The effective emitting region 28 and the non-effective emitting regions 26 are set based on the uniformity of the brightness, and only light emitted from the effective emitting region 28 in which the brightness is relatively uniform is utilized as illumination light. Herein, if the entire length of the light guide plate 12 is X, a length Z of the non-effective emitting regions 26 is “(X−Y)/2”.

The underside surface 20 of the spread illuminating apparatus 10 includes: a center region 24 that has a length of A, that is provided at the center in the light guide direction and in which an optical path conversion unit (not illustrated) is formed; and side regions 22 that are positioned at the outsides of the center region 28 (the incident light surface 13 side and the incident light surface 15 side) and in which no optical path conversion unit is formed.

In the optical path conversion unit formed in the center region 24, light that has entered the light guide plate 12 through the incident light surfaces 13 and 15 and reached the center region 24 of the underside surface 20 is reflected mainly toward the effective emitting region 28 of the emitting surface 19 and reaches the emitting surface 19 at an incident angle that is at or below a critical angle. Thereby the propagated light is uniformly emitted from the effective emitting region 28 of the emitting surface 19, and the emitted light enters the two-sided prism sheet 14 at an appropriate incident angle.

Similar to the linear prisms formed on an underside surface 136 of a light guide plate 125 shown in FIG. 2, this kind of optical path conversion unit typically includes a plurality of linear prisms that extend approximately parallel to the incident light surfaces 13 and 15. Preferably, a cross-section of the linear prisms that is vertical relative to the extension direction has a triangular shape with a relatively large apex angle (for example, 160° or more).

Meanwhile, the side regions 22 are divided from the center region 24 side to the incident light surfaces 13 and 15 into a region 22b (also referred to as “B region” below) that has a prescribed length B in the light guide direction, a region 22c (also referred to as “C region” below) that has a prescribed length C, and a region 22d (also referred to as “D region” below) that has a prescribed length D. Light absorbers 32 and 34 are respectively formed in the C regions 22c included in the side regions 22 toward the incident light surfaces 13 and 15. The light absorbers 32 and 34 are formed in a strip shape that extends parallel to the lengthwise direction (direction orthogonal to the paper surface in FIG. 1) of the incident light surfaces 13 and 15, and the extension range is typically the entire width of the light guide plate 12.

The light absorbers 32 and 34 can be formed by, for example, performing black printing or applying black paint to the C regions 22c on the underside surface 20. Alternatively, they can also be formed by disposing a black member including a black substrate such as a black PET film or the like on the C regions 22c. When doing so, the black member can be affixed to the C regions 22c by a bonding adhesive or a tacky adhesive or the like. The black member to be used can have a multi-layer structure in which a plurality of black substrate layers are stacked upon each other via a bonding adhesive (or a tacky adhesive).

Further, if the black member is bonding adhered or tacky adhered to the C regions 22c, a black pigment or the like can be mixed into the bonding adhesive or tacky adhesive to form the light absorbers 32 and 34 with the black member and the bonding adhesive or tacky adhesive. Alternatively, if the optical sheet 16 is to be fixed by bonding adhesion or tacky adhesion to the underside surface 20 of the light guide plate 12 without disposing a black member, a black pigment or the like can be mixed into the bonding adhesive or tacky adhesive used in the portions to be applied to the C regions 22c among the bonding adhesive or tacky adhesive interposed between the optical sheet 16 and the underside surface 20 of the light guide plate 12, and the light absorbers 32 and 34 can thereby be formed by such a bonding adhesive or tacky adhesive.

The length “B+C+D” of the side regions 22 is “(X−A)/2” when the entire length of the light guide plate 12 is X. However, in the spread illuminating apparatus 10, the side regions 22 can also be formed such that one or both of the length B of the B regions 22b and the length D of the D regions 22d are 0. In other words, the side regions 22 include a case in which they include only the B region 22b and the C region 22c, a case in which they include only the C region 22c and the D region 22d, and a case in which they include only the C region 22c.

Further, in the spread illuminating apparatus 10, the light absorbers 32 and 34 formed in the side regions 22 toward the incident light surfaces 13 and 15 are regions that are more toward the incident light surfaces 13 and 15 than the effective emitting region 28. In other words, the side regions 22 toward the incident light surfaces 13 and 15 are formed such that at least the C regions 22c are positioned more toward the incident light surfaces 13 and 15 than the effective emitting region 28 (such that “C+D<Z”).

Preferably, the side regions 22 toward the incident light surfaces 13 and 15 are formed so that their entire length is positioned more toward the incident light surfaces 13 and 15 than the effective emitting region 28, and in this case, “B+C+D <Z” (or in other words, “A>Y”).

Next, the operational effects of the spread illuminating apparatus 10 configured as described above will be explained below based on the embodiments shown in the following table.

TABLE 1

| Sample Number | D [mm] | C [mm] | B [mm] | Crosstalk [%] |
|---|---|---|---|---|
| S1 | 5 | 0 | 0 | 8.0 |
| S2 | 2 | 1 | 2 | 5.2 |
| S3 | 3 | 2 | 0 | 4.1 |
| S4 | 0 | 2 | 3 | 3.9 |
| S5 | 2 | 3 | 0 | 3.6 |
| S6 | 1 | 3 | 1 | 3.5 |
| S7 | 0 | 3 | 2 | 3.2 |
| S8 | 0 | 5 | 0 | 2.9 |

In spread illuminating apparatus samples S1 to S8 used for measurement, the entire length X of the light guide plate 12 was set to 108 mm and the length Y of the effective emitting region 28 was set to 94 mm (therefore, the length Z of the non-effective emitting regions 26 was 7 mm),

Crosstalk is defined as crosstalk (%)=[{(left eye brightness when right-side light source is illuminated/left eye brightness when left-side light source is illuminated)+(right eye brightness when left-side light source is illuminated/right eye brightness when right-side light source is illuminate)}/2]×100.

Right eye brightness when left-side light source is illuminated and left eye brightness when left-side light source is illuminated are respectively the brightness in the right eye direction and the brightness in the left eye direction of the viewer in the spread illuminating apparatus 10 when a left-side image light source (for example, the light source 18) is illuminated and a right-side image light source (for example, the light source 17) is turned off. Similarly, right eye brightness when right-side light source is illuminated and left eye brightness when right-side light source is illuminated are respectively the brightness in the right eye direction and the brightness in the left eye direction of the viewer in the spread illuminating apparatus 10 when a right-side image light source 17 is illuminated and a left-side image light source 18 is turned off.

In the samples S1 to S8 in the above table, the length B+C+D of the side regions 22 is 5 mm (therefore, the length A of the center region 24 is 98 mm), and the entirety of each side region 22 is disposed more toward the incident light surfaces 13 and 15 than the effective emitting region 28 (B+C+D<Z). Further, among the samples S1 to S8, the samples S2 to S8 are examples of the spread illuminating apparatus 10 according to the present embodiment, in which the light absorbers 32 and 34 are formed in the side regions 22 (C>0 mm). On the other hand, the sample Si is a comparative example in which the light absorbers 32 and 34 are not formed in the side regions 22 (C=0 mm). In the samples S2 to S8, the light absorbers 32 and 34 correspond to black printing.

As shown in the above table, in the samples S2 to S8, crosstalk is reduced compared to the sample S1. These results demonstrate that in the samples S2 to S8, light that has entered the light guide plate 12 from one incident light surface 13 or 15 and then is guided toward the other incident light surface 15 or 13 without being emitted from the light emitting surface 19 is at least partially absorbed by the light absorber 34 or 32 formed in the C region 22c toward the other incident light surface 15 or 13 before reaching the other incident light surface 15 or 13, and thereby light that is emitted after being reflected by the other incident light surface 15 or 13, which is a factor leading to crosstalk, is reduced.

Further, comparing the samples S2 to S8, it can be understood that crosstalk is further reduced as the length C of the C regions 22c (in other words, the strip width of the light absorbers 32 and 34 that are formed in a strip shape) increases. Also, comparing the samples S3 and S4 and the samples S5 to S7, it can be understood that crosstalk is further reduced as the length D of the D regions 22d decreases when the length C of the C regions 22c is the same (or in other words, as the formation position of the light absorbers 32 and 34 approaches the incident light surfaces 13 and 15).

In addition, in the spread illuminating apparatus 10, by forming the light absorbers 32 and 34 in regions that are more towards the incident light surfaces 13 and 15 than the effective emitting region 28 (or in other words, by forming them within the range of the non-effective emitting regions 26) of the underside surface 20 of the light guide plate 12, in addition to effectively absorbing light which is a factor leading to crosstalk as explained above, light which has entered from one of the incident light surfaces 13 and 15 of the light guide plate 12 and would immediately be emitted from the non-effective emitting regions 26 near the incident light surfaces 13 and 15 in the case that the light absorbers 32 an 34 did not exist, which is a factor leading to the occurrence of bright lines, is also effectively absorbed. Thereby, the occurrence of bright lines in the non-effective emitting regions 26 can be suppressed and the uniformity of the brightness can be improved.

Due to the above, the length Z of the non-effective emitting regions 26 that exist near the incident light surfaces 13 and 15 of the emitting surface 19 of the light guide plate 12 can be reduced, and thus the entire length X of the light guide plate 12 that is necessary for securing the effective emitting region 28 of a prescribed length Y can be reduced, and this contributes to size reduction of the spread illuminating apparatus 10.

Light that is emitted from the non-effective emitting regions 26 is not utilized as illumination light in the first place in a conventional spread illuminating apparatus. Therefore, in the spread illuminating apparatus 10, even if there is light which has entered from one of the incident light surfaces 13 and 15 of the light guide plate 12 and is immediately absorbed by the light absorbers 32 and 34 formed in the C regions 22c toward the incident light surfaces 13 and 15, the brightness of the illumination light in the spread illuminating apparatus 10 is hardly reduced compared to a conventional spread illuminating apparatus.

Comparing the samples S2 to S8, focusing only on the effect of crosstalk reduction, the structure in which the light absorbers 32 and 34 are formed over the entire side regions 22 (sample S8) is preferable. However, in the spread illuminating apparatus 10, the following effects can be achieved by providing the B regions 22b and the D regions 22d, which are flat surfaces in the side regions 22 in which the light absorbers 32 and 34 are not formed.

If flat surface portions (one or both of the B regions 22b and the D regions 22d) are included in the side regions 22, light which has entered from one of the incident light surfaces 13 and 15 and then reaches the flat surface portions of the side regions 22 is guided toward the other incident light surface 15 or 13 without being emitted from the non-effective emitting regions 26 opposite to the side regions 22. Therefore, although the flat surface portions act in a direction that increases light which is a factor leading to crosstalk, they also decrease light emitted from the non-effective emitting regions 26 similar to the C regions 22c in which the light absorbers 32 and 34 are formed. Thus, the flat surface portions achieve an effect of improving the uniformity of the brightness. In addition, the flat surface portions also have a feature that is different from the C regions 22c in which the light absorbers 32 and 34 are formed in that they do not absorb light that reaches the flat surface portions of the side regions but rather guide it toward the other incident light surface 15 or 13. Therefore, the flat surface portions achieve an effect of improving the brightness of the effective emitting region 28.

The present inventors have also confirmed that if the B regions 22b exist in the side regions 22, by disposing the entirety of the side regions 22 including the B regions 22b more toward the incident light surfaces 13 and 15 than the effective emitting region 28 (in other words, setting “B+C+D<Z”), the uniformity of the brightness is further improved.

In this way, in the spread illuminating apparatus 10, if the length “B+C+D” of the side regions 22 is fixed, the effect of reducing crosstalk increases as the proportion of the length C of the C regions 22c relative to the length “B+C+D” increases, and the effect of improving the brightness increases as the proportion of the length “B+D” of the B regions and the D regions increases. Therefore, in the spread illuminating apparatus 10, the proportion of the length C of the C regions 22e relative to the length “B+C+D” of the side regions is set appropriately considering the balance of the above-described effects.

In the spread illuminating apparatus 10 explained above referring to FIG. 1, the light absorbers 32 and 34 are formed on the underside 20 of the light guide plate 12. However, in the spread illuminating apparatus according to the present invention, the light absorbers 32 and 34 can be formed on the emitting surface 19 of the light guide plate 12, or can be formed on both the emitting surface 19 and the underside surface 20 of the light guide plate 12. Thereby, the same operational effects as those described above regarding the spread illuminating apparatus 10 can be achieved.

In the spread illuminating apparatus 10, a light blocking sheet disposed so as to cover the top of the non-effective emitting regions 26 (and preferably the top of the light sources 17 and 18) can be included.

1. A spread illuminating apparatus comprising:
a light guide plate in which two side end surfaces that oppose each other are incident light surfaces and one of two principal surfaces that oppose each other is an emitting surface; and
a pair of light sources that are respectively arranged along the two incident light surfaces of the light guide plate and that are alternately illuminated,
wherein light absorbers are formed in regions toward the incident light surfaces of one or both of the principal surfaces of the light guide plate.

2. The spread illuminating apparatus according to claim 1, wherein the light absorbers are formed in a strip shape that extends parallel to a lengthwise direction of the incident light surfaces of the light guide plate.

3. The spread illuminating apparatus according to claim 1, wherein the light absorbers are formed in regions that are more toward the incident light surfaces than an effective emitting region disposed at the center in a light guide direction of the emitting surface of the light guide plate.

4. The spread illuminating apparatus according to claim 1, wherein a two-sided prism sheet is disposed on the emitting surface side of the light guide plate.
